(19) United States
(12) Patent Application Publication
(10) Pub. No.: US 2010/0142723 A1
(43) Pub. Date: Jun. 10, 2010

(54) Multimedia Switching Over Wired Or Wireless Connections In A Distributed Environment

(76) Inventor: Willard Kraig BUCKLEN, Greensboro, NC (US)

Correspondence Address: KENYON & KENYON LLP, 1500 K STREET, NW, WASHINGTON, DC, 20005-1257, US

(21) Appl. No.: 12/630,945

(22) Filed: Dec. 4, 2009

Related U.S. Application Data
(60) Provisional application No. 61/120,592, filed on Dec. 8, 2008.

(51) Int. Cl. H04B 3/00

(52) U.S. Cl. 381/81

(57) ABSTRACT

The present invention may include a wireless AV transmission system to support wireless transmission of AV data from an AV source device to an AV sink device. Each sink device may be associated with an AV output component, for example, a speaker. The sink devices each may have a unique address in the system. During operation, AV data having a format corresponding to a wired data protocol may be modulated onto RF channels and broadcast to the AV sink device(s). Each AV sink device may identify portion(s) of the RF channels that contain data to be output at the sink device and any timing signals to be decoded to keep the sink devices synchronized. Each AV sink device may demodulate and decode its respective AV channel from within the RF broadcasts, synchronize operation to the timing references in the broadcast signal and output its respective AV channel data.

### CROSS-REFERENCE TO RELATED APPLICATIONS

This application claims priority from U.S. Provisional Patent Application No. 61/120,592, filed on Dec. 8, 2008, which is incorporated herein in its entirety.

### FIELD OF THE INVENTION

The present invention generally is directed to an audio/video (AV) distribution system. In particular, the present invention is directed to a system and method for delivering AV content from AV source devices to AV sink devices such as distributed speakers over a wireless or wired network.

### BACKGROUND INFORMATION

Audio and video signals traditionally have been exchanged between components of entertainment systems in separate audio and video wires. This facilitates routing AV signals to different sinks such as television sets and speakers. Recently, a number of standards such as the High-Definition Multimedia Interface (HDMI) (High-Definition Multimedia Interface, Specification Version 1.3a, Nov. 10, 2006, which is incorporated by reference in its entirety) and Digital Interactive Interface for Video and Audio (DiiVA) (DiiVA Specification, Version 1.0a, Apr. 29, 2009, which is incorporated by reference in its entirety) have been proposed and/or adopted as a single-cable interconnect that connects different components of home entertainment systems.

Entertainment systems based on these standards may simply include an AV source connected to an AV sink via a single AV interconnect. The AV source may be a DVD player or set-top box connected to a cable outlet. The AV sink may be a television set. The AV sink may receive an AV stream and a clock signal from the AV source via the single interconnect and convert the AV stream into separate audio and video data streams to be transmitted separately to a display screen and speakers.

High end entertainment systems of current standards may also include a signal splitter (such as an HDMI repeater) residing between a source device and a sink device. Under HDMI, the HDMI repeater is a device that includes both an HDMI input and an HDMI output. A typical

HDMI repeater may be an HDMI-capable AV receiver. For example, an AV receiver may be coupled at the input to one or more HDMI sources via HDMI interconnects, and at outputs, coupled to a television and multiple speakers. The AV receiver may pass along the HDMI channels to the TV. Further, the AV receiver may decode the audio channels for each speaker and transmit the decoded audio streams through separate audio wires to speakers.

FIG. 1 shows an HDMI interconnect from an HDMI source device to an HDMI sink device. The single cable HDMI interconnect has four Transition Minimized Differential Signaling (TMDS) pairs, and additionally a Display Data Channel (DDC) and optionally, a CEC channel. The TMDS pairs carry three data channels and one clock channel. The TMDS data channels transmit audio, video and auxiliary data from the source to the sink. The TMDS clock channel transmits a TMDS clock (typically, running at video pixel rate) from the source to the sink. Thus, the sink uses the TMDS clock as a reference to the AV data transmitted through TMDS data channels. The DDC channel acts as a back channel to transmit device information data from the HDMI sink to the HDMI source. For example, the HDMI sink stores extended display identification data (EDID) in an EDID ROM from which the HDMI source retrieves content in the EDID ROM via the DDC. The device information is used to determine capacity and characteristics of the sink.

Under HDMI, the video, audio, and auxiliary data are combined into a single data stream, and transmitted through pins corresponding to the TMDS channels 0-2 over one of three types of time periods—the Video Data Periods, the Data Island Periods, and the Control Periods. The video signal including data representing pixels is transmitted during the Video Data Periods. The audio signal and auxiliary data is transmitted as packets of data during the Data Island Periods—which occur during the vertical and horizontal blanking intervals of video images. The Control Period occurs between Video Data and Data Island Periods. Present HDMI standard supports up to 16-bit video along with up to 8 channels of uncompressed audio. In this way, all of the AV content is transmitted from a source to a sink in a single combined AV data stream to reduce the number of individual connections and maintain synchronization among the signals.

Another AV interconnect standard is the Digital Interactive Interface for Video & Audio (also known as DiiVA). Similar to HDMI, DiiVA is a standard for transmitting AV content from a source device to a sink device over a single interconnect. Under DiiVA, the interconnect has four links (or twisted pairs)—three video links and one hybrid link. Unlike HDMI, DiiVA transmits audio data via the hybrid link and thus in a separate link from the video links. Each of the DiiVA links is a bi-directional high-speed data channel that transmits data downstream (from the source to the sink) or upstream (from the sink to the source). The DiiVA transmission is half-duplex because the downstream and upstream transmissions occur alternatively—i.e. the source device and the sink device take turns being a transmitter and a receiver. Thus, the AV content transmission under DiiVA is also point-to-point.

Thus, home entertainment systems based on HDMI or DiiVA are inherently point-to-point interconnect systems—i.e., one AV source is connected to one AV sink. Therefore, there is a need for a flexible transmission architecture where multiple AV sinks are connected to an AV source without the point-to-point limitation.

### BRIEF DESCRIPTION OF THE DRAWINGS

FIG. 1 shows an HDMI interconnect from an HDMI source device to an HDMI sink device.

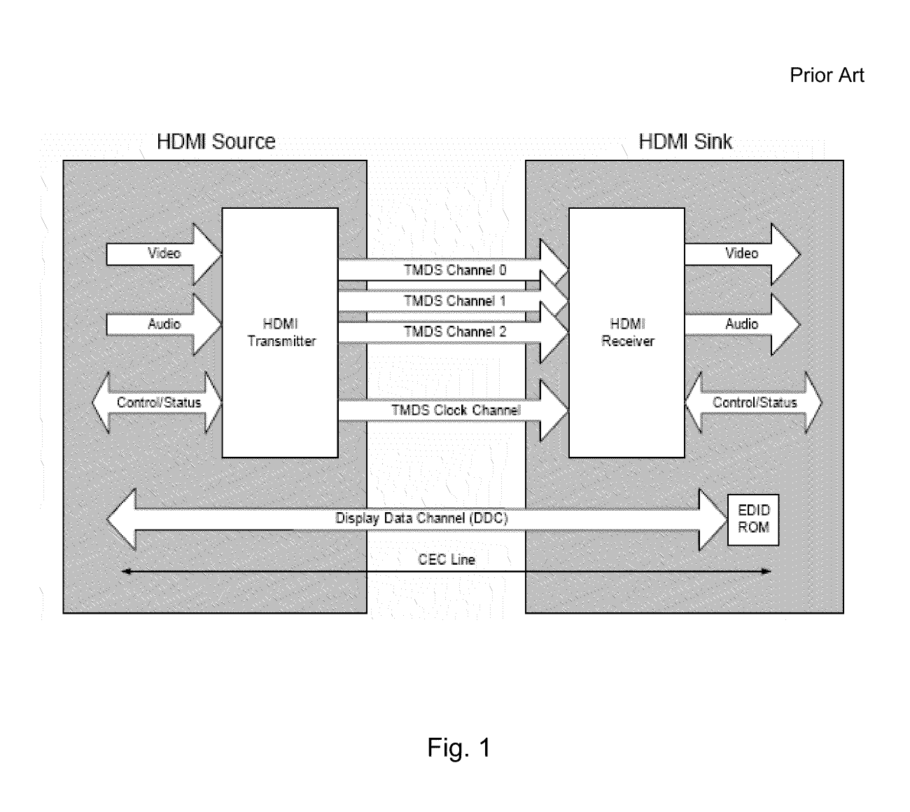

FIG. 2 illustrates a system diagram of an addressable wireless speaker according to an embodiment of the present invention.

FIG. 3 illustrates a system diagram of channel coding of AV signals according to an embodiment of the present invention.

FIG. 4 illustrates system diagram of channel decoding of RF signals according to an embodiment of the present invention.

FIG. 5 illustrates a flow chart of a method for processing and playing audio on a wireless speaker according to an embodiment of the present invention.

FIG. 6 illustrates a cross-functional diagram of a method for processing and playing audio in an addressable HDMI speaker according to an embodiment of the present invention.

FIG. 7 illustrates a system diagram of wireless speakers in an HDMI-based content distribution system according to an embodiment of the present invention.

FIG. 8 illustrates a system diagram of wireless speakers in an DiiVA-based content distribution system according to an embodiment of the present invention.

FIG. 9 is a cross-functional diagram of a method for synchronizing AV data according to an embodiment of the present invention.

### DETAILED DESCRIPTION

Embodiments of the present invention may include a wired or wireless AV transmission system to support transmission of AV data from an AV source device to multiple AV sink devices. Each sink device may be associated with an AV output component, for example, a speaker or a display device. The sink devices each may have a unique address in the system. During operation, AV data having a format corresponding to a combined AV data protocol may be transmitted over a wired network or modulated onto RF channels to be transmitted to the AV sink device(s). Each AV sink device may identify portion(s) of the RF channels that contain data to be output at the sink device and any timing signals to be decoded to keep the sink devices synchronized. Each AV sink device may demodulate and decode its respective AV channel from within the RF broadcasts, synchronize operation to the timing references in the broadcast signal and output its respective AV channel data.

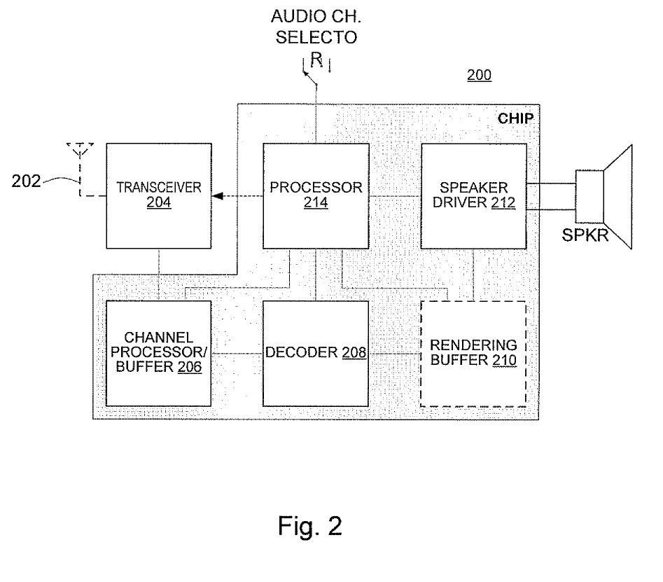

FIG. 2 is a system diagram of an addressable speaker according to an embodiment of the present invention. The speaker may operate according to HDMI, DiiVA, or other AV standards. The speaker 200 may include an RF antenna 202, a transceiver 204, a channel processor/buffer 206, a decoder 208, optionally a rendering buffer 210, a speaker driver 212, a processor 214, and a speaker. It is noted that the embodiment is discussed using the RF antenna 202 as an illustrative example. However, the present invention is not limited to network connections using an antenna. In another embodiment, the antenna may be replaced with a network interface for a wired connection without materially changing functionalities of the system. The transceiver 204 may be coupled to the antenna 202 to receive and demodulate signals received from an AV source such as an HDMI or DiiVA source device. Further, the transceiver 204 may optionally transmit RF signals carrying the back channel data to the AV source. The channel processor/buffer 206 may be coupled to the transceiver 204 to store AV signals recovered by the transceiver, isolate signals specific to the audio channel to which the speaker is assigned, and route channel-specific signals to the decoder 208. The decoder 208 may be an audio decoder that is coupled to the channel processor/buffer 206 to recover the audio stream from the compressed audio. In some embodiments, an optional rendering buffer 210 may be coupled between the decoder 208 and the speaker driver 212 to delay the delivery of the audio to the speaker by a dynamically established delay. The amount of delays may be tailored to synchronize audio output at multiple speakers. The speaker driver 212 may generate analog audio signals based on the output of the decoder to drive the speaker. The processor 214 may be coupled to components 204-212 to provide centralized processing power and control. The processor 214 may receive an external signal that identifies the role of the wireless speaker (shown as an audio channel selector) and may configure operation of the channel processor 206 accordingly. Further, the processor 214 may determine a delay to be applied by the rendering buffer 210. Finally, the processor 214 may generate back channel messages to be transmitted to an AV source via the transceiver 204.

In operation, the RF antenna 202 may be capable of receiving RF signals transmitted by an AV source device and also capable of broadcasting RF signals from the wireless speaker to the AV source. For example, in an embodiment corresponding to HDMI, the RF signal may carry separate HDMI channels including a TMDS clock channel, three separate TMDS data channels, and a data display channel (DDC). These system may establish unique transmission channels for each channel in the governing AV standard via channelization techniques such as frequency modulation (RM), code-division multiple access (CDMA), orthogonal frequency division multiple access (OFDM), band division multiple access (BDMA) and ultra wideband (UWB). When acting as a receiver, the transceiver 204 may perform demodulation and channel-decoding of the RF signal carrier to recover the AV signals. When acting as a transmitter, the transceiver 204 may perform modulation and coding of data into signals to be transmitted over the RF antenna. In some embodiments, the transceiver 204 may be capable of receiving and distinguishing RF signals transmitted at different frequency bands, each of which may correspond to a different RF channel.

The channel processor/buffer 206 may store the captured AV signals. Further, the channel processor/buffer may filter the AV signal to extract audio data specific to the wireless speaker (or video data for a display) and route the extracted audio data to the decoder 208. Further, the channel processor/buffer may be configured to regenerate an audio clock signal from the video clock for controlling the audio play. The audio clock may be generated for each wireless speaker based on a reference clock signal such as the video clock and a predetermined ratio coded in the AV signal. When the audio stream is coded according to a compression scheme such as MP3, the decoder 208 may decode the audio stream into an uncompressed audio stream. The optional rendering buffer may be used to insert delays into the audio streams by processor 214 for synchronized AV play at multiple AV sink devices.

Systematic computation and control may be achieved through processor 214. The processor 214 may configure the channel processor/buffer 206 to perform audio channel selection and audio data filtering. Further, the processor 214 may be configured to determine performance parameters such as delays in audio play to allow the wireless speaker to transmit these performance parameters back to the AV source device. The processor 214 also may be configured to insert a time adjustment received from the AV source device into the audio stream recovered from the decoder and store the adjusted audio stream in rendering buffer 210.

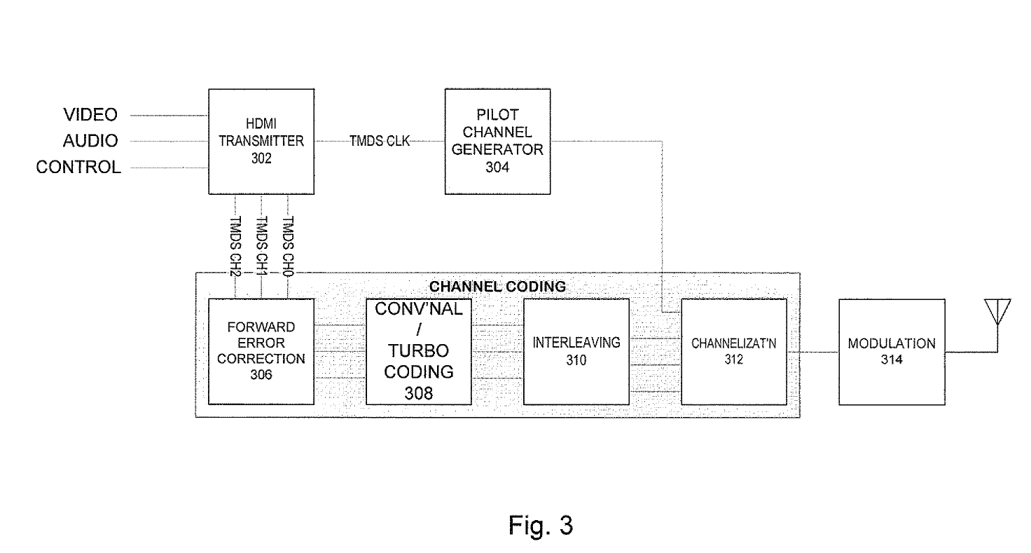

The signal transmitted from the AV source to AV sinks may be channel-coded using channel coding methods. FIG. 3 is a block diagram of transmitter for an HDMI source according to an embodiment of the present invention. The transmitter of an AV source may include an AV transmitter 302, a pilot channel generator 304, a forward error correction unit 306, a convolutional coder/turbo coder 308, an interleaver 310, a channelization unit 312, and a modulator 314. The AV transmitter 302 may generate AV data channels from input video, audio and control signals. FIG. 3 illustrates an example corresponding to HDMI in which the AV data channels are TMDS channels. The pilot channel generator 304 may generate a pilot channel from the AV protocol's clock signals (TMDS CLK in the example of HDMI). The pilot channel may not carry information content of the AV signal, but may provide a timing reference for reception and decode of the other channels transmitted by the transmitter. The forward error correction unit 306 may apply an error correction code to each of the AV data channels. The error correction code may add redundancy to each of the AV data channels which can facilitate error detection and correction at a receiver in the event of RF interference. For example, the error correction code may be applied as a cyclic redundancy code. The convolutional coder/turbo coder 308 may apply a second level of error correction code to the AV data channels. The interleaver 310 may perform bit shuffling of the coded AV channels to further protect against interference in the transmission environment. The channelization unit 312 may assign each of the AV channels (the clock channel and data channels illustrated in FIG. 3) to corresponding RF transmission channels according to the governing access protocol. For example, in a frequency modulation system, the AV channels may be assigned to respective frequency modulated channels. In a spread spectrum system, the AV channels may be assigned to respective spreading codes. Finally, the modulator 314 may modulate a carrier using the transmission signals according to the governing access scheme.

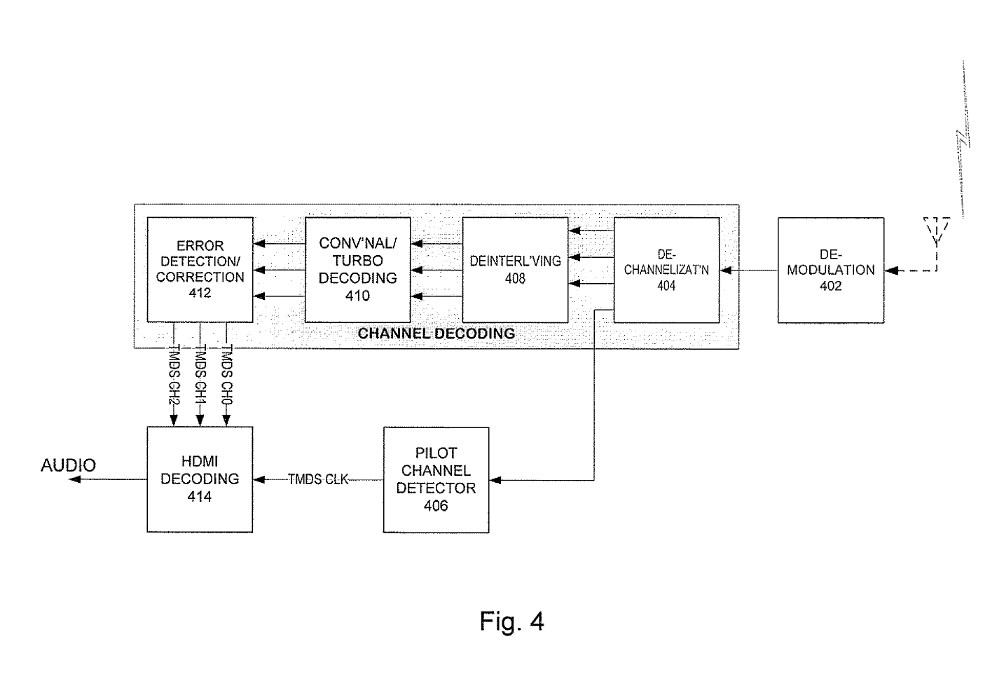

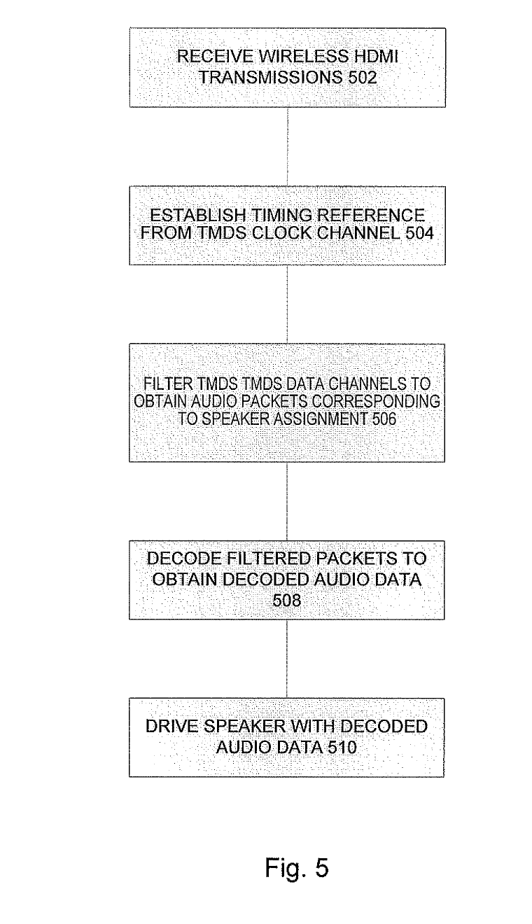

The signal received at AV sinks may be decoded using channel decoding methods. FIG. 4 illustrates a block diagram of a receiver according to an embodiment of the present invention. The receiver may include a demodulator 402, a de-channelization unit 404, a pilot channel detector 406, a deinterleaver 408, a convolutional decoder/turbo decoder 410, an error correction unit 412, and an AV decoding unit 414. The demodulator 402 may recover transmission signals from the RF signal received at an antenna. The de-channelization unit 404 may recover signals carrying AV channels from the received transmission signals. Continuing with the examples above, in a frequency modulation system, the system may recover separate AV signal streams, e.g., the clock channel and data channels, from the frequency shifted channels. In a spread spectrum system, the system may de-spread the received transmission signal according to spreading codes. The pilot channel detector 406 may recover a timing signal from the received transmission signal. The timing signal may govern timing of AV processing (e.g., FIG. 5) and also reception processing of the receiver of FIG. 3. The deinterleaver 408 may invert the interleaving processing applied by the transmitter. The convolutional decoder/turbo decoder 410 may decode the deinterleaved signals and recover digital bit streams. The error correction unit 412 may identify and correct bit errors in the output of the convolutional decoder/turbo decoder unit. The output of the error correction unit may be the receiver's final estimate of the AV signals transmitted by the transmitter. The AV decoding unit 414 may filter audio data corresponding to the speakers channel assignment.

In some embodiments, the modulated AV signals may be broadcasted and transmitted from an AV source to multiple AV sinks such as a number of AV speakers over a wireless network. Each of the AV sinks may extract content destined to the respective sink and ignore content destined for other sinks. FIG. 5 illustrates a flow chart for a method of processing and playing audio on a wireless speaker according to an embodiment of the present invention. The method may provide following. At 502, the wireless speaker may receive an RF signal carrying AV signals. The wireless speaker may perform channel decoding to extract and separate the AV clock and data channels. The channel decoding may be carried out in a manner as described in connection with FIG. 3. At 504, the wireless speaker may generate an independent audio time reference based on a video clock carried in the AV clock channel for audio play. At 506, the wireless speaker may filter the data channels 0-2 to extract audio packet data designated for the wireless speaker. The extracted audio data may be uncompressed or compressed audio data. If the audio data is compressed, at 508, the wireless speaker may recover the audio data using an audio decoder. Finally, at 510, audio stream may be fed to a speaker driver to drive a speaker.

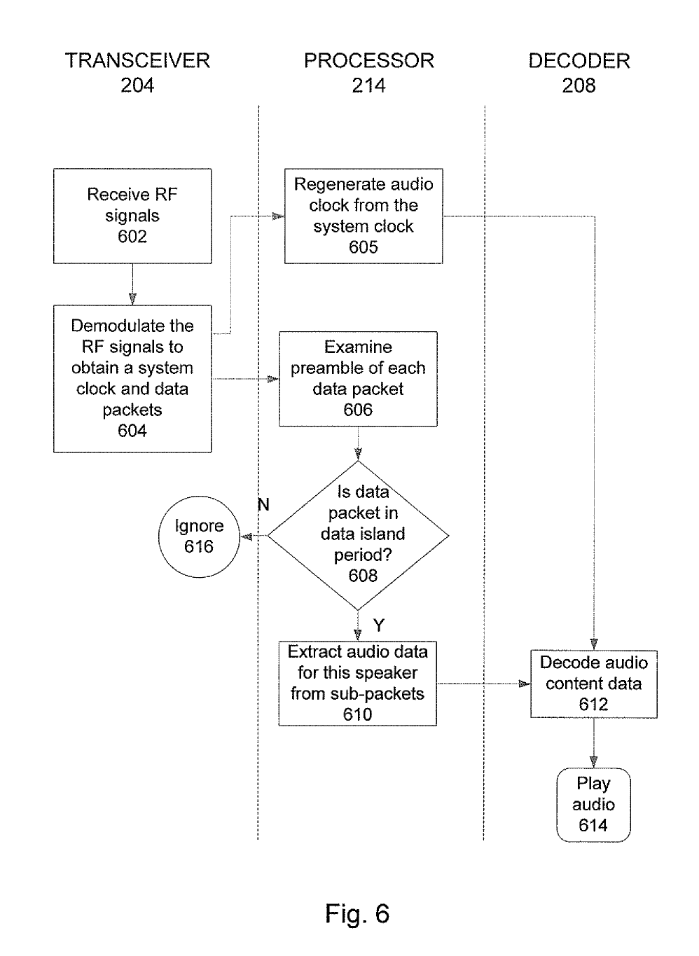

FIG. 6 is a cross-functional diagram of a method for processing and playing audio in an addressable HDMI speaker according to an embodiment of the present invention. The method may provide the following. At 602, the transceiver 204 may receive RF signals carrying one TMDS clock channel, three TMDS data channels, and one data display channel. At 604, the transceiver 204 along with the channel processor 206 may dechannelize the RF signals to obtain a video clock in the TMDS clock channel and data packets of the three TMDS data channels and DDC. At 605, the processor 214 may regenerate a separate audio clock in reference to the video clock and transmit the audio clock signal as a timing reference to an audio processing unit for controlling audio play at a speaker. Concurrently, at 606, the processor 214 may examine preambles of data packets to determine whether a data packet belongs to the Video Data Period, the Data Island Period, or the Control Period of the HDMI signal. For the wireless HDMI speaker, only the Data Island Period is relevant because audio data is stored therein. At 608, packets not in Data Island Period may be ignored. Otherwise, at 610, an audio addressed to the speaker may be extracted from sub-packets to construct an audio stream. At 612, the audio stream may be decoded according to the audio clock signal and then played at 614 based on the timing signal and the content.

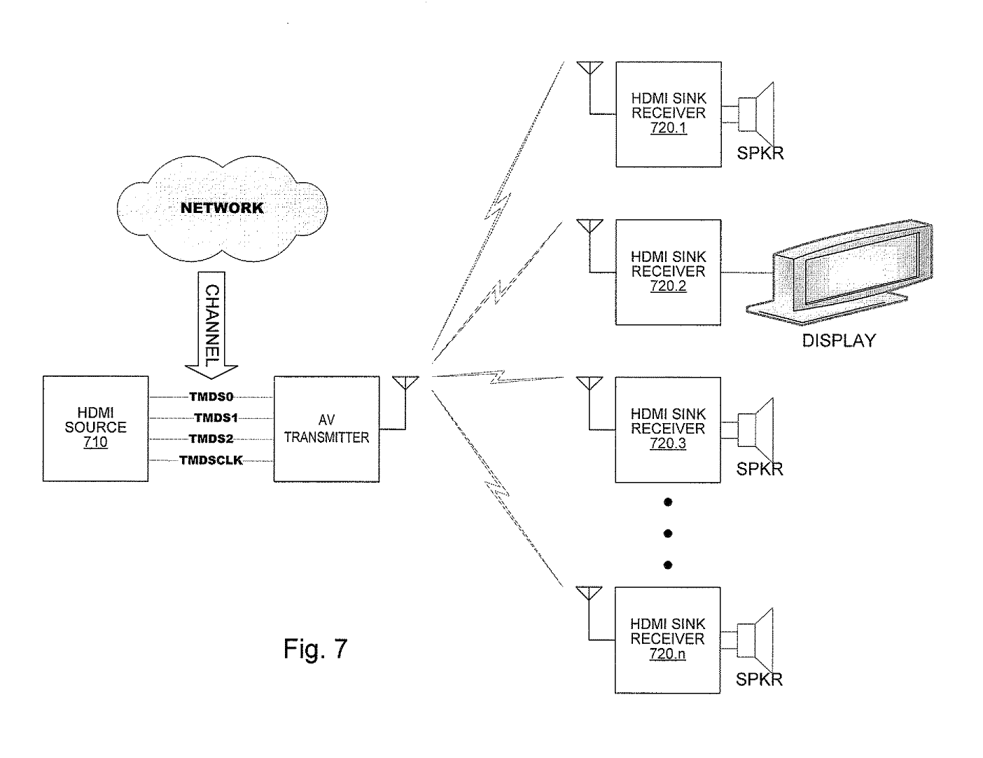

In some embodiments, an AV system may include multiple wireless speakers. FIG. 7 illustrates a system diagram of wireless speakers and a display in an HDMI-based content distribution system according to an embodiment of the present invention. The HDMI wireless speaker system may include an HDMI source device 710 that may include an RF transceiver, a number of addressable wireless HDMI receivers 720.1-4, each including components as described in FIG. 2, and an HDMI video sink 720.2 that may display video on a screen.

In this embodiment, the HDMI source device 710 may be an AV source device such as a DVD player or set-top box coupled to a network outlet that is capable of outputting AV data based on the HDMI specification. The HDMI source device may include an RF transceiver and a processor. The processor may be configured to convert AV data into packets. The RF transmitter/transceiver of the source device may broadcast data packets of the AV data over the air to HDMI receivers 720.1-4. In one embodiment, the RF transmitter/receiver may modulate the TMDS data channels 0-2 and TMDS clock channel at different frequency bands so that the HDMI sinks may distinguish data packets of different channels by the different frequency bands. In another embodiment, the data packets of different channels may be transmitted in the same RF frequency band, but coded using a channel coding scheme such as CDMA. The wireless HDMI speakers may work as described in connection with FIG. 2.

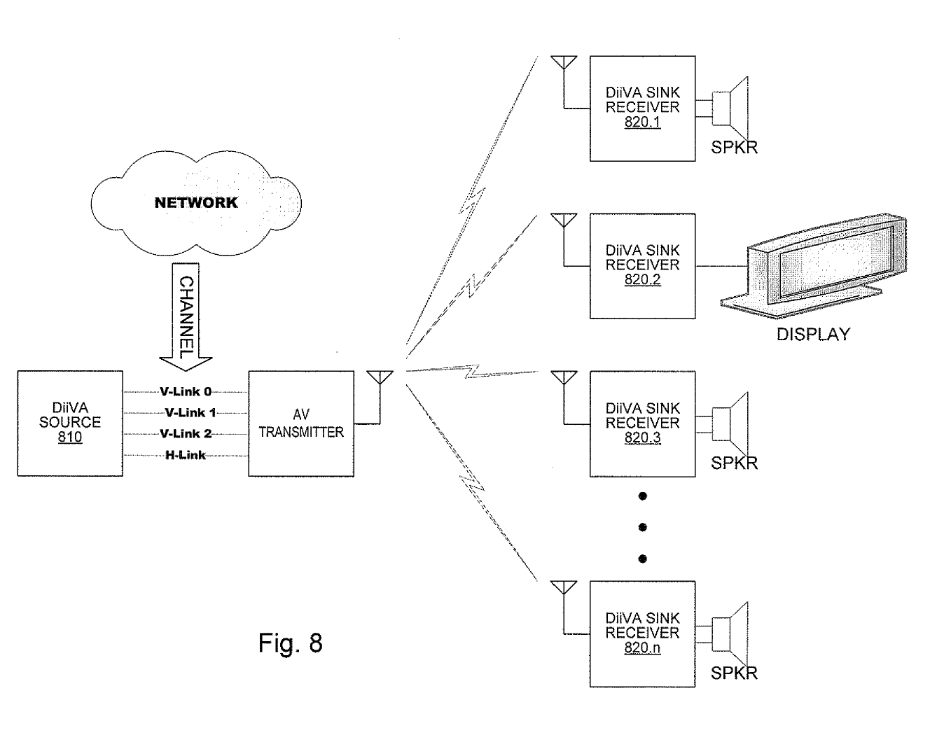

Correspondingly, FIG. 8 illustrates a system diagram of wireless speakers in a DiiVA-based content distribution system according to an embodiment of the present invention. The DiiVA wireless speaker system may include a DiiVA source device 810 that may include an RF transceiver, a number of addressable wireless DiiVA receivers 820.1-4, each including components as described in FIG. 2, and a DiiVA video sink 820.2 that may display video on a screen.

Similar to the HDMI system, the HDMI source device 810 may be an AV source device such as a DVD player or set-top box coupled to a network outlet that is capable of outputting AV data based on the DiiVA protocol. The DiiVA source device may include an RF transceiver and a processor. The processor may be configured to convert AV data into packets. The RF transmitter/transceiver of the source device may broadcast data packets of the AV data over the air to DiiVA receivers 820.1-4. In one embodiment, the RF transmitter/receiver may modulate transmission channels corresponding to the video links 0-2 and the hybrid link of the DiiVA protocol at different frequency bands so that the DiiVA sinks may distinguish data packets of different channels by the different frequency bands. In another embodiment, the data packets of different channels may be transmitted in the same RF frequency band, but coded using a channel coding scheme such as CDMA. The wireless DiiVA speakers similarly may work as described in connection with FIG. 2.

In some embodiments, the connections between the AV source and sinks may be a mix of wireless and wired connections. For example, in one embodiment, the video sink may be connected to the AV source via a wired connection while the speakers are connected to the source via a wireless connection. The wireless HDMI speakers may operate in the same manner as described in FIG. 2.

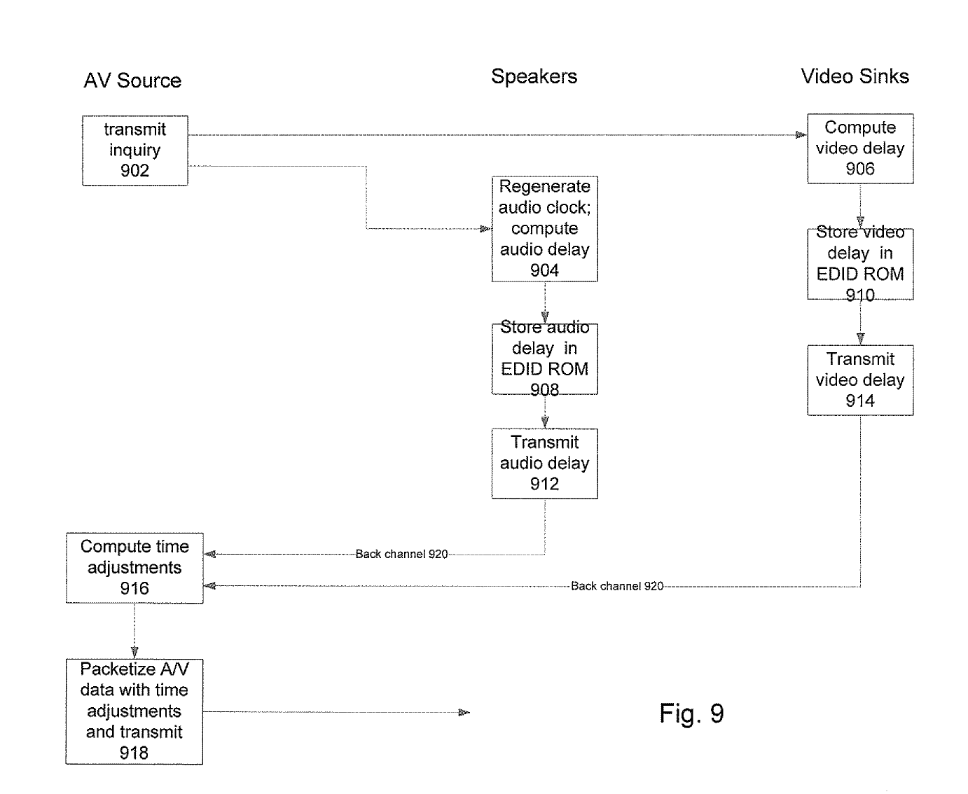

One aspect of the present invention is to synchronize audio and video contents among AV receivers. FIG. 9 is a cross-functional diagram of a method for synchronizing AV data according to an embodiment of the present invention. The method may provide the following. At 902, an AV source device may transmit inquiries to addressable AV speakers and a video sink. The inquiry may include a test sequence in AV data channels (such as the TMDS data channels of HDMI or video links and the hybrid link of DiiVA) and a video clock. At 904, a processor in each respective wireless speaker may generate an audio clock based on the video clock and compute an audio delay for the speaker based on the test sequence and the audio clock. For an embodiment implementing the HDMI protocol, the audio clock may be generated as described in High-Definition Multimedia Interface, Specification Version 1.3a (Nov. 13, 2006). For another embodiment implementing the DiiVA protocol, the audio clock may be generated as described in Digital Interactive Interface for Video and Audio, Specification Version 1.0a (Apr. 29, 2009). Based on the generated audio clock and hardware capabilities of the speaker, at 908, the wireless speakers each may compute an audio delay and store the delay as part of EDID data in an EDID ROM of the wireless speaker. Similarly, at 906, the video sink may compute a video delay based on the video clock and hardware capabilities of the video sink and store the video delay in an EDID ROM of the video sink 910. At 912 and 914, the speakers and the video sink may transmit the audio delays and video delay to the HDMI source via back channels. Under HDMI, the back channel may include the DDC over the wireless network. Under DiiVA, since the video links and the hybrid link are bi-directional, the back channel may be the same video links and hybrid link during upstream transmission periods. At step 916, the source may compute time adjustments for each AV sinks for synchronized AV play based on received data representing delays in video and audio sinks. In one embodiment, the adjustments may be computed as the largest of the video and audio delays so that the AV data may be played in sync. At 918, the HDMI source may then packetize AV data account for the time adjustments and transmit the AV data packet over the wireless network to the speakers and the video sink.

Another aspect of the present invention is to control speaker volumes on the network instead of individually on each speaker. In one embodiment, the systems of FIGS. 7 and 8 may also include a remote control for controlling the system operation. A user may adjust a volume control on the remote control. The remote control may then transmit a signal indicating the adjustment via a data link such as the CEC link to the AV source device. The AV source device may then adjust a volume parameter in the AV data packet transmitted to each of the speakers.

In one embodiment of the present invention, the home entertainment system may be from one source device to multiple players. In an alternative embodiment of the present invention, the home entertainment system may be from multiple sources to multiple players. For example, the video source may be from a set-top box while the audio source may be from a DVD player. In this way, the present invention may provide flexibility to home entertainment systems. Further, the present invention eliminates the need and cost of an AV receiver as an intermediate component.

The AV wireless transmission may be configured to work cooperatively with legacy devices. In one embodiment, the AV wireless transmission functionality may be implemented as a networked adaptor that may be coupled to legacy AV devices to enable wireless AV functionality. The networked adaptor may include a processor, and an RF transmitter and receiver configured to receive and process AV data packets as described in FIG. 2.

According to one example embodiment of the present invention, the address of an AV player may be set by setting jumpers of a dip switch. Alternatively, the address may be stored in a computer-readable medium, e.g., a ROM, which may be set by software. In one embodiment, the wireless speaker may include a memory for storing an address of the wireless speaker. The address may be set by a manufacturer or alternatively, the address may be set by a user through the network.

Those skilled in the art may appreciate from the foregoing description that the present invention may be implemented in a variety of forms, and that the various embodiments may be implemented alone or in combination. Therefore, while the embodiments of the present invention have been described in connection with particular examples thereof, the true scope of the embodiments and/or methods of the present invention should not be so limited since other modifications will become apparent to the skilled practitioner upon a study of the drawings, specification, and following claims.

What is claimed is:

1. A method of playing audio on a speaker, comprising:
receiving a radio frequency (RF) signal that carries transmission channels that transmit audio and video (AV) data and clock data;
channel-decoding the RF signal to separate each of the transmission channels;
extracting from the transmission channels AV data and clock data;
extracting from the AV data an audio stream that is addressed to the speaker;
regenerating an audio clock for the speaker based on the clock data;
if the audio stream is compressed, audio-decoding the audio stream; and
transmitting the audio stream to a speaker driver to play the audio stream based on the audio clock.

2. The method of claim 1, further comprising:
receiving a test AV sequence;
determining a time delay of audio play on the speaker based on executing the test sequence, and
playing the audio stream to play account for the time delay.

3. The method of claim 1, wherein three transmission channels respectively correspond to three video channels, and one additional transmission channel corresponds to a clock channel, wherein the audio data is part of the video channels.

4. The method of claim 1, wherein three transmission channels respectively correspond to three video links, and one additional transmission channel corresponds to a hybrid link, wherein the audio data is part of the hybrid link and the clock is part of the video and hybrid links.

5. The method of claim 1, wherein the transceiver receives the signal over a communication network.

6. A speaker, comprising:
a storage to store an address of the speaker;
a transceiver to receive a radio frequency (RF) signal that carries transmission channels that transmit AV data and clock data and perform channel decoding to separate each of the transmission channels;
a processor configured to:
extract from the transmission channels AV data and clock data;
extract from the AV data an audio stream that is addressed to the speaker; and
regenerate an audio clock for the speaker based on the clock data; and
an audio decoder to decode the audio stream when the audio stream is compressed; and
a speaker driver to drive a speaker based on the audio stream and the audio clock.

7. The speaker of claim 6, wherein the processor is configured to further determine a time delay of audio play on the speaker and play the audio stream with an account for the time delay.

8. The speaker of claim 6, wherein three transmission channels respectively correspond to three video channels, and one additional transmission channel corresponds to a clock channel, wherein the audio data is part of the video channels.

9. The speaker of claim 6, wherein three transmission channels respectively correspond to three video links, and one additional transmission channel corresponds to a hybrid link, wherein the audio data is part of the hybrid link and the clock is part of the video and hybrid links.

10. The speaker of claim 6, wherein the transceiver receives the signal over a communication network.

11. An HDMI speaker, comprising:
a storage to store an address of the HDMI speaker;
a transceiver to receive a radio frequency (RF) signal that carries transition minimized differential signaling (TMDS) channels including three data channels and one clock channel, wherein each of the data channel carries audio and video data and the clock channel carries a video clock and to perform channel-decoding to separate each of the data channels and the clock channel;
a processor configured to:
extract from the data channels audio packets;
determine whether the audio packets are destined to the address of the HDMI speaker;
if so, store the audio packets to form an audio stream in a buffer; and
regenerate an audio clock for the HDMI speaker based on the clock channel; and
an audio decoder to decode the audio stream when the audio stream is compressed; and
a speaker driver to drive a speaker with the audio stream.

12. The HDMI speaker of claim 11, wherein each data channel is temporally partitioned into video data periods, data island periods and control periods.

13. The HDMI speaker of claim 12, wherein the audio packets are extracted from data island periods.

14. The HDMI speaker of claim 11, wherein the processor is configured to read preambles of audio packet to determine destination of the audio packets.

15. The HDMI speaker of claim 11, wherein the transceiver receives the signal over a communication network.

16. A DiiVA speaker, comprising:
a storage to store an address of the DiiVA speaker;
a transceiver to receive a radio frequency (RF) signal that carries three video links and one hybrid link, the video links transmitting video data and the hybrid link transmitting audio data, both video and hybrid link transmitting a clock, and to perform channel decoding to separate each of the video and hybrid links;
a processor configured to:
extract from the hybrid link audio packets;
extract from the hybrid link a clock signal;
determine whether the audio packets are destined to the address of the DiiVA speaker;
if so, store the audio packets to form an audio stream in a buffer; and
regenerate an audio clock for the DiiVA speaker based on the clock signal; and
an audio decoder to decode the audio stream when the audio stream is compressed; and
a speaker driver to drive a speaker with the audio stream.

17. The DiiVA speaker of claim 16, wherein the processor is configured to read preambles of audio packet to determine destination of the audio packets.

18. A speaker system, comprising:
a source device to channel-code an RF signal that carries data channels and one clock channel;
a display device to receive the RF signal;
a plurality of wireless speakers, each speaker further including:
a storage to store an address of the speaker;
a transceiver to receive a radio frequency (RF) signal that carries transmission channels including data channels and one clock channel, wherein each of the data channels carries audio and video data and the clock channel carries a video clock and to perform channel decoding to separate each of the data channels and the clock channel;
a processor configured to:
extract from the data channels audio packets;
determine whether the audio packets are destined to the address of the speaker;
if so, store the audio packets to form an audio stream in a buffer;
regenerate an audio clock for the speaker based on the clock channel; and
determine a time delay of the audio stream based on capacity of the speaker; and
an audio decoder to decode the audio stream when the audio stream is compressed; and
a speaker driver to drive a speaker with the audio stream.

19. The speaker system of claim 18, wherein the transceiver of each speaker transmits the time delay to the source device for which to determine time adjustments for each respective wireless speakers.

20. The speaker system of claim 19, wherein the source device transmits time adjustments to each wireless speaker for accounting for the time adjustments in audio play at the each respective wireless speakers.
